(19) United States
(12) Patent Application Publication
(10) Pub. No.: US 2025/0332909 A1
(43) Pub. Date: Oct. 30, 2025

(54) GRILLE SHUTTER DEVICE

(71) Applicant: TOYOTA JIDOSHA KABUSHIKI KAISHA, Toyota-shi (JP)

(72) Inventor: Katsuichiro HIRAKAWA, Toyota-shi (JP)

(73) Assignee: TOYOTA JIDOSHA KABUSHIKI KAISHA, Toyota-shi (JP)

(21) Appl. No.: 19/027,730

(22) Filed: Jan. 17, 2025

(30) Foreign Application Priority Data
Apr. 24, 2024 (JP) 2024-070705

(51) Int. Cl. B60K 11/08

(52) U.S. Cl. CPC B60K 11/085

(57) ABSTRACT

The grille shutter device includes a frame provided at a vehicle front portion and forming an opening portion for introducing air into the vehicle front portion, a plurality of fin portions supported by the frame so as to be rotatable about the vehicle width direction or the vehicle vertical direction as an axis, and opening and closing the opening portion, and a dropping mechanism provided at at least one of both end portions in the axial direction on the vehicle inner side of the frame and causing the fin portion to fall off at the time of collision.

### CROSS-REFERENCE TO RELATED APPLICATION

This application claims priority to Japanese Patent Application No. 2024-070705 filed on Apr. 24, 2024, incorporated herein by reference in its entirety.

### BACKGROUND

### 1. Technical Field

The present disclosure relates to a grille shutter device.

### 2. Description of Related Art

Japanese Unexamined Patent Application Publication No. 2013-107534 (JP 2013-107534 A) below discloses a structure capable of causing a front grille to smoothly retract at the time of collision of a vehicle. The structure is configured by providing, in a frame that supports a shutter mechanism in an opening portion, a fixing portion that rotatably fixes one end in the opening portion and a protruding portion that protrudes forward. In this manner, the structure is configured such that the frame rotates with the fixing portion adopted as a support point and retracts by the protruding portion abutting the front grille when the front grille retracts.

### SUMMARY

Incidentally, in a case where a vehicle collision occurs when the shutter is fully closed, guided air may not be obtained from the opening portion. There is thus a structure that prevents a cooling function loss by splitting the opening portion into a left part and a right part and securing a function of either one of the left and right parts. However, a pillar is present at a center of the opening portion in a vehicle width direction in this structure, which leads to a decrease in opening area of the opening portion. Therefore, in order to suppress the cooling function loss, the opening portion which is desired to be reduced in size in terms of design should be increased in size in some cases. In the structure described in JP 2013-107534 A, only the retracting of the frame may not address the case when the opening portion is fully closed, and there is room for improvement.

The present disclosure has been made in view of the above circumstances, and an object of the present disclosure is to obtain a grille shutter device capable of suppressing a cooling function loss while securing an opening area.

A grille shutter device according to the present disclosure described in claim 1 includes:
a frame that is provided at a vehicle front portion and forms an opening portion to introduce air into the vehicle front portion;
a plurality of fin portions that are supported by the frame such that the fin portions are rotatable about an axis in a vehicle width direction or a vehicle up-down direction and open and close the opening portion; and
a dropping mechanism that is provided on at least one side of both end portions of the frame in a direction of the axis inside the vehicle and causes the fin portions to drop at time of collision.

In the grille shutter device according to the present disclosure described in claim 1, the plurality of fin portions that open and close the opening portion to introduce air into the vehicle front portion are caused to drop by the dropping mechanism at the time of collision of the vehicle. It is thus possible to suppress a cooling function loss by the fin portions dropping at the time of collision while securing an opening area of the opening portion, without splitting the opening portion.

In the grille shutter device according to the present disclosure described in claim 2, the dropping mechanism includes a notch that is provided at an attachment position of a rotation shaft of the fin portions in the frame and is open on a vehicle rear side, in the configuration described in claim 1.

In the grille shutter device according to the present disclosure described in claim 2, the dropping mechanism includes the notch that is provided at the attachment position of the rotation shaft of the fin portions in the frame and is open in the vehicle front-rear direction. Therefore, the notch spreads to make it easy for the fin portions to drop when the frame is deformed to project on the vehicle rear side at the time of collision by the notch being open on the vehicle rear side in the frame.

In the grille shutter device according to the present disclosure described in claim 3, the plurality of fin portions rotates with the vehicle up-down direction adopted as the direction of the axis, in the configuration described in claim 2.

In the grille shutter device according to the present disclosure described in claim 3, the plurality of fin portions rotates with the vehicle up-down direction adopted as the direction of the axis, and it is thus possible to make it easier for the notch to spread in the frame with a curvature in the vehicle width direction.

In the grille shutter device according to the present disclosure described in claim 4, the notch is provided on a lower edge side of the frame and includes a bottom surface having a tapered shape that is lowered toward a vehicle rear side, in the configuration described in claim 2 or 3.

In the grille shutter device according to the present disclosure described in claim 4, since the notch provided on the lower edge side of the frame includes the bottom surface having the tapered shape that is lowered toward the vehicle rear side, it is easier to push the fin portions backward, and it is thus possible to make it easy to cause the fin portions to drop.

In the grille shutter device according to the present disclosure described in claim 5, the notch penetrates through the frame, in the configuration described in any one of claims 1 to 3.

In the grille shutter device according to the present disclosure described in claim 5, the notch penetrates through the frame, and it is thus possible to cause the fin portions to drop in a frame penetrating direction as well.

As described above, according to the grille shutter device of the present disclosure, it is possible to achieve an excellent effect that a cooling function loss can be suppressed by the fin portions dropping at the time of collision while an opening area of the opening portion is secured, without splitting the opening portion.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view schematically showing an example of a grille shutter device according to a first embodiment of the present disclosure;

FIG. 2 is a plan view schematically showing a notch;

FIG. 3 is a perspective view schematically illustrating a part of a fin portion of the grille shutter device of FIG. 1;

FIG. 4 is a perspective view for explaining the detachment by the dropping mechanism; and

FIG. 5 is a plan cross-sectional view schematically showing an example of a grille shutter device according to a second embodiment of the present disclosure.

### DETAILED DESCRIPTION OF EMBODIMENTS

### First Embodiment

Hereinafter, a grille shutter device 10 according to a first embodiment of the present disclosure will be described with reference to the accompanying drawings. In the present specification and the drawings, constituent elements having substantially the same functional configuration are denoted by the same reference numerals, and redundant description thereof will be omitted. The arrows FR, the arrows UP, and the arrows RH shown in the drawings indicate the front side, the upper side, and the right side of the grille shutter device 10, respectively. Further, directions opposite to each of the arrows FR, UP, and RH indicate a rear side, a lower side, and a left side, respectively. Hereinafter, in the case of simply describing the front-rear direction, the left-right direction, and the up-down direction, the front-rear direction, the left-right direction, and the up-down direction of the grille shutter device 10 in the front-rear direction, and the up-down direction of the grille shutter device will be described unless otherwise specified. Further, the grille shutter device 10 is mounted on a vehicle such that a front side thereof is a vehicle front side (traveling direction), an upper side thereof is a vehicle upper side, and a right side thereof is a vehicle right side. Therefore, when the grille shutter device 10 is mounted on a vehicle, the front side, the upper side, and the right side of the grille shutter device 10 are the front side, the upper side, and the right side of the vehicle.

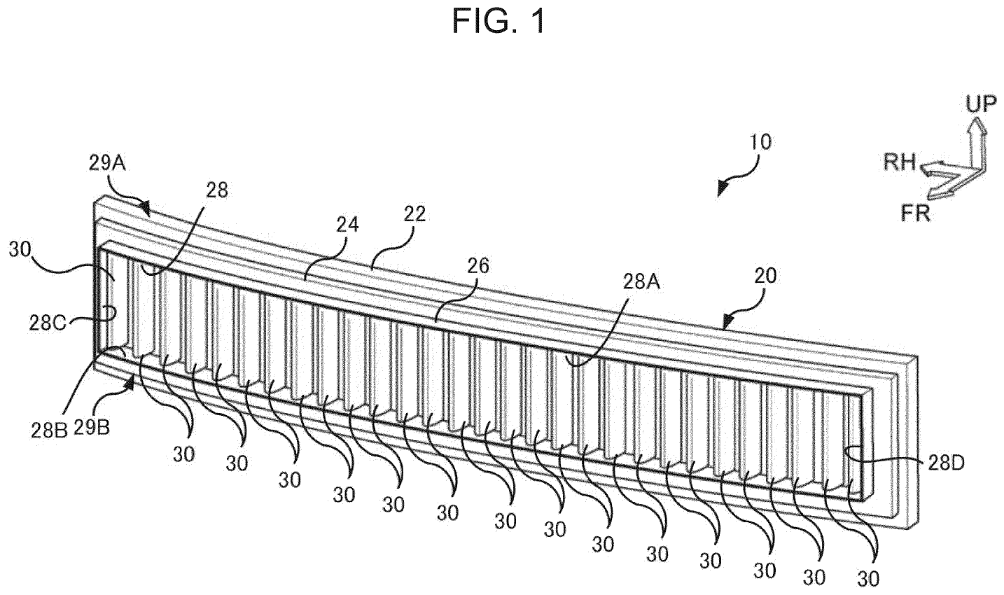

As illustrated in FIG. 1, the grille shutter device 10 includes a frame 20, a plurality of fin portions 30, and a dropping mechanism 40.

The frame 20 is formed in a rectangular frame shape, and includes, as an example, a rectangular first frame 22, a rectangular second frame 24 smaller than the first frame 22, and a rectangular third frame 26 smaller than the second frame 24. In the frame 20, the first frame 22, the second frame 24, and the third frame 26 are arranged to overlap each other in this order from the rear side toward the front side. That is, in the frame 20, a step is formed in the frame. The frame 20 includes a rectangular opening portion 28 extending through the first frame 22, the second frame 24, and the third frame 26. Note that the frame 20 may be formed of one frame without a step.

As an example, the frame 20 is attached to the front portion of the vehicle such that the opening portion 28 faces an outside air introduction opening (not shown) provided in the front grille of the vehicle, and air (outside air) is introduced into the front portion of the vehicle from the opening portion 28. In the present embodiment, the frame 20 is curved so as to have a convex shape toward the front side in the left-right direction. Specifically, it is curved substantially in the same manner as the design surface of the vehicle.

The opening portion 28 includes an upper inner surface 28A, a lower inner surface 28B, a right inner surface 28C, and a left inner surface 28D. The upper inner surface 28A is provided with a plurality of holes (not shown) at regular intervals along the longitudinal direction, and the lower inner surface 28B is provided with a plurality of notches 42, which will be described later, at positions facing the plurality of holes.

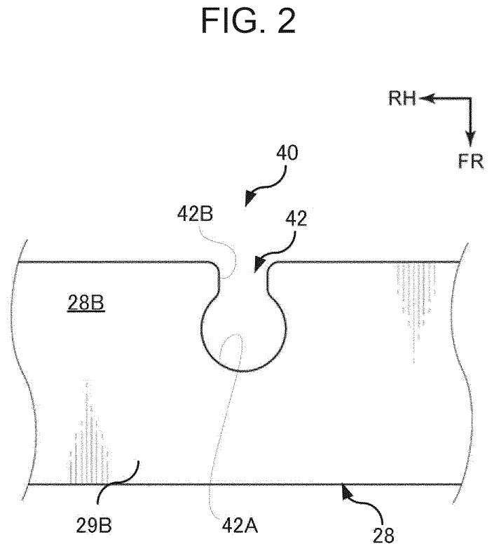

As shown in FIG. 2, the notch 42 corresponds to the dropping mechanism 40 of the present disclosure, and is formed so as to penetrate through the lower wall 29B having the lower inner surface 28B of the frame 20. The notch 42 is provided rearward of the center of the lower wall 29B in the front-rear direction, and includes a substantially circular portion 42A, and a notch portion 42B cut out in a substantially rectangular shape from the rear end of the lower wall 29B toward the circular portion 42A and communicating 25 with the circular portion 42A. That is, the rear side of the notch 42 is opened.

Further, the plurality of holes (not shown) provided in the upper inner surface 28A are also formed in a substantially circular shape, and the center thereof is formed so as to coincide with the center of the circular portion 42A of the notch 42 in a top view. The plurality of holes may or may not pass through the upper wall 29A having the upper inner surface 28A. In the present embodiment, as an example, it is assumed that it does not penetrate.

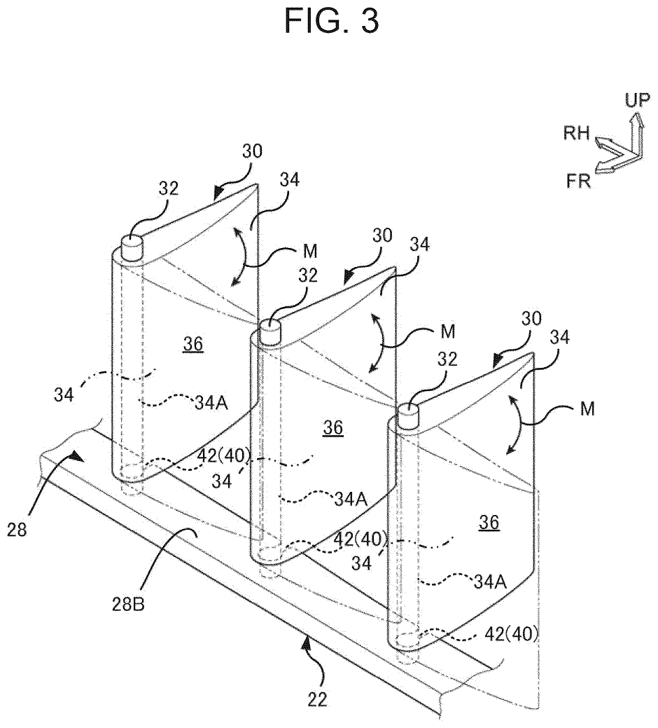

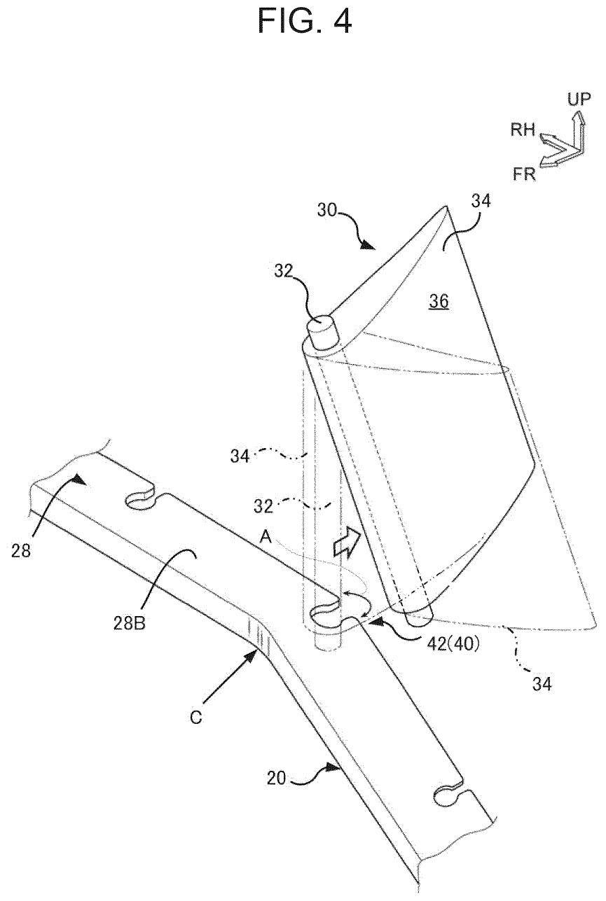

As illustrated in FIG. 3, the plurality of fin portions 30 are provided inside the opening portion 28. Although not shown in FIGS. 3 and 4, the lower wall 29B has a step as shown in FIG. 1. Each of the plurality of fin portions 30 includes a rotation shaft 32 which is rotatably supported in a vertical direction by a hole provided in the upper wall 29A and a notch 42 provided in the lower wall 29B. The rotation shaft 32 is formed in an elongated cylindrical shape (in other words, a rod shape), and fins 34 each having a fin shape are provided on the rotation shaft 32.

In an open state in which the opening portion 28 is opened, the fin 34 is formed such that, for example, the lateral direction is the plate thickness direction and the plate thickness gradually decreases toward the rear. The fin 34 is provided with an insertion hole 34A through which the rotation shaft 32 is inserted into a front end portion when the fin is opened. The fin 34 is formed as the main surface 36 having the widest surface in the left-right direction in the open state. In addition, the fin 34 is, for example, curved so as to be curved along the curvature of the frame 20 when the opening portion 28 is closed.

In the present embodiment, as an example, the upper end of the rotation shaft 32 is connected to an actuator (not shown) provided on the right outer side of the frame 20, for example. The actuator rotates the fin 34 in the direction of the arrow M in FIG. 3 by rotationally driving the rotation shaft 32 with the vertical direction as an axial direction, thereby opening and closing the opening portion 28. Since a known technique can be used for the connection method between the rotation shaft 32 and the actuator, a detailed description thereof will be omitted.

Then, as shown in FIG. 3, in the open state in which the opening portion 28 is opened, the main surface 36 of the fin 34 faces in the left-right direction as indicated by a solid line. Further, as shown in FIG. 3, in a closed state in which the opening portion 28 is closed, the main surface 36 of the fin 34 faces the front-rear direction as indicated by a two-dot chain line.

### Operations and Effects of First Embodiment

Next, operations and effects of the first embodiment will be described.

In the grille shutter device 10 according to the present embodiment, the plurality of fin portions 30 for opening and closing the opening portion 28 for introducing air into the vehicle front portion are dropped off by the notch 42 as the dropping mechanism 40 when the vehicle collides. Specifically, as shown in FIG. 4, when a load from the front indicated by an arrow C is applied to the lower wall 29B of the frame 20, for example, when the vehicle collides forward, the lower wall 29B is pushed by the load and deforms such that the rear is convex. At this time, since the rear side of the notch 42 provided on the rear side of the lower wall 29B is opened, the notch 42 is widened as indicated by the arrow A. As the notch 42 expands in this manner, the lower end of the rotation shaft 32 is easily disengaged from the notch 42 toward the rear side.

When the lower end of the rotation shaft 32 is removed from the notch 42, the fin portion 30 falls due to gravitational force, so that the support of the upper end of the rotation shaft 32 by the upper wall 29A of the frame 20 can also be removed. Therefore, even in a case where the opening portion 28 is closed by the fin portion 30, the fin portion 30 is disengaged from the frame 20 at the time of collision, so that air guide can be obtained from the opening at the position where the fin portion 30 is disengaged. Thus, without dividing the opening portion 28, while securing the opening area of the opening portion 28, it is possible to suppress the cooling function loss by the fin portion 30 falls off at the time of collision.

Further, in the grille shutter device 10 according to the present embodiment, since the plurality of fin portions 30 rotate in the vehicle vertical direction as the axial direction, the notch 42 can be more easily widened in the frame 20 having the curvature in the vehicle width direction.

Further, in the grille shutter device 10 according to the present embodiment, since the notch 42 penetrates in the lower wall 29B of the frame 20, the fin portion 30 can be dropped off also in the penetration direction of the lower wall 29B. When the fin portion 30 falls in the downward direction, which is the penetrating direction, the support of the upper end of the rotation shaft 32 by the upper wall 29A can be easily disengaged.

### Second Embodiment

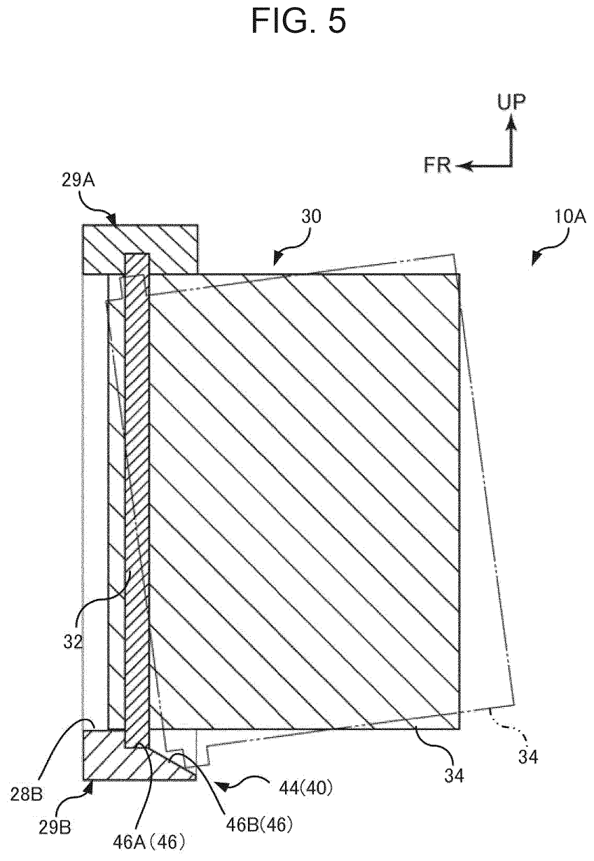

Next, a grille shutter device 10A according to a second embodiment will be described. FIG. 5 is a plan cross-sectional view schematically illustrating an exemplary grille shutter device 10A according to the second embodiment. In the grille shutter device 10A according to the second embodiment, the same components as those of the above-described first embodiment are denoted by the same reference numerals, and description thereof is omitted.

The notch 42 as the dropping mechanism 40 of the first embodiment described above penetrates through the lower wall 29B of the frame 20. On the other hand, the notch 44 as the dropping mechanism 40 of the grille shutter device 10A according to the second embodiment includes the bottom surface 46 without penetrating in the lower wall 29B.

As shown in FIG. 5, the notch 44 is provided on the rear edge side of the lower wall 29B, which is the lower edge side of the frame 20. The notch 44 has a bottom surface 46, and the bottom surface 46 includes a circular portion 46A formed in a substantially circular shape and a tapered portion 46B communicating with the circular portion 46A and having a tapered shape decreasing toward the rear side Operations and Effects of Second Embodiment

Next, operations and effects of the second embodiment will be described.

In the grille shutter device 10A according to the present embodiment, the notch 44 provided on the rear edge side of the lower wall 29B, which is the lower edge side of the frame 20, has a bottom surface 46 having a tapered shape that decreases toward the rear side. Therefore, when a load is applied to the fin portion 30 from the front when the vehicle collides forward, the fin portion 30 is easily pushed backward, so that the fin portion can be easily dropped off.

### Supplementary Explanation

In the above-described embodiment, the rotation shaft 32 of the fin portion 30 is formed in an elongated shape, but the present disclosure is not limited thereto. The rotation shaft 32 may be formed of a cylindrical projection extending in the up-down direction from the upper end surface and the lower end surface on the front side of the fin 34 in the open state. Further, the fin 34 and the rotation shaft 32 may be integrally formed or may be separately formed.

In the above-described embodiment, the notch 42 is formed only on the lower wall 29B of the frame 20, but the present disclosure is not limited thereto, and the notch 42 may be formed on the upper wall 29A.

Further, in the above-described embodiment, the plurality of fin portions 30 are configured to rotate in the vertical direction as the axial direction, but the present disclosure is not limited thereto. The plurality of fin portions 30 may be configured to rotate about the left-right direction. In this case, the dropping mechanism 40 is provided on the left and right walls of the frame 20.

Further, in the above-described embodiment, notches 42 and 44 are provided as the dropping mechanism 40, but the dropping mechanism 40 is not limited to the notches 42 and 44. The dropping mechanism 40 may have, for example, a hole as a support portion for supporting the rotation shaft 32 of the fin portion 30, and the wall on the rear side of the hole may be fragile.

Further, the configuration of the present disclosure is not limited to the above-described embodiment, and the configuration can be changed as appropriate as long as the problem can be solved.

What is claimed is:

1. A grille shutter device comprising:
a frame that is provided at a vehicle front portion and forms an opening portion to introduce air into the vehicle front portion;
a plurality of fin portions that are supported by the frame such that the fin portions are rotatable about an axis in a vehicle width direction or a vehicle up-down direction and open and close the opening portion; and
a dropping mechanism that is provided on at least one side of both end portions of the frame in a direction of the axis inside the vehicle and causes the fin portions to drop at time of collision.

2. The grille shutter device according to claim 1, wherein the dropping mechanism includes a notch that is provided at an attachment position of a rotation shaft of the fin portions in the frame and is open on a vehicle rear side.

3. The grille shutter device according to claim 2, wherein the plurality of fin portions rotates with the vehicle up-down direction adopted as the direction of the axis.

4. The grille shutter device according to claim 2, wherein the notch is provided on a lower edge side of the frame and includes a bottom surface having a tapered shape that is lowered toward a vehicle rear side.

5. The grille shutter device according to claim 2, wherein the notch penetrates through the frame.
